(19) United States
(12) Patent Application Publication
(10) Pub. No.: US 2014/0032339 A1
(43) Pub. Date: Jan. 30, 2014

(54) Method and System for Advertising Using Quick Response Codes

(71) Applicant: Oded Blum, Mitspe Adi (IL)

(72) Inventor: Oded Blum, Mitspe Adi (IL)

(21) Appl. No.: 13/947,127

(22) Filed: Jul. 22, 2013

(30) Foreign Application Priority Data
Jul. 26, 2012 (IL) 221153

(51) Int. Cl. G06Q 30/02

(52) U.S. Cl. CPC G06Q 30/0277
USPC 705/14.73

(57) ABSTRACT

A method and system for advertising using a quick response code that includes (a) a set of quick response codes that can be purchased as an off-the-shelf product in the form of stickers or a computer file whereby the purchasing entity remains anonymous vis-à-vis the selling entity; (b) a website that enables the purchaser to design, manage and store unique, designated web pages for each quick response code or for the set of quick response codes, as desired; (c) storage space on a server designated for the relevant quick response codes; (d) a website operating system that enables access to the site management system and to the web page management system; and (e) the option of accessing and entering the relevant web pages on a standard computer.

### TECHNICAL FIELD

The present invention refers to a method and system for advertising using quick response codes that enables off-the-shelf and anonymous purchasing of quick response codes as well as access to server space on the barcode company's server and the possibility of using the site management system on the said server. The invention also refers to a method and system that enable to surf and enter the relevant webpage using a standard computer.

### BACKGROUND ART

Advertising and displaying information on webpages, which are accessible to the general public by scanning quick response codes using a smart phone, is a relatively new area of activity that is gaining momentum constantly. Advertising using quick response codes is performed as follows: (a) The advertiser uploads content to a web page that may be accessed and surfed using a designated quick response code. (b) The advertiser prints the quick response code in the form of a barcode on a newspaper, business card, flyer, etc. (c) The customer simply scans the quick response code using a smartphone and is immediately directed and granted access to the web page.

Advertising using quick response codes, as opposed to standard advertising in newspapers, catalogs, and so on, enables the advertiser to expose potential customers to updated, changing and interactive content. It offers quick access to information the customer is interested in, which the advertiser wishes to present to the customer. Finally, it enables the advertiser to designate a separate and unique web page to each quick response code or to each set of quick response codes.

Advertising using quick response codes may be applied in a wide variety of cases and methods. Quick response codes may be printed, for instance, on business cards, so as to enable quick access to a designated web page that contains information about the business or firm; on conference participants lists whereby each participant is allocated a unique quick response code that directs the viewer to a web page containing information about the said participant; in newspapers, catalogs, advertising pamphlets, etc. so as to grant the general public access to specific web pages that contain updated, detailed and more extensive information about the advertiser and his products.

The entity that sells advertisers barcodes also sells them space on its server, or on a server operated on its behalf, as well as a system for managing the website and the web pages in the said server space. Thus, using the website's management system, the advertiser may designate a separate web page to each quick response code or to a set of specific quick response codes.

For the sake of clarity and fluency of explanation, we will use the following terms: “Advertising using a quick response code” refers to the above-described method and system, which includes access and entry, using a smartphone, to unique web sites designated for specific quick response codes or for specific sets of quick response codes. The “barcode company” is the entity that manufactures and markets the quick response codes, allocates server space and grants purchasers access to the site management system. “Advertisers” are those entities who purchase quick response codes, server space, and access to the site management system from the barcode company. Advertisers may be manufacturers, marketers, business people, professionals, government or municipal entities, and in fact any entity that wishes to present information to the general public or to a defined target audience. “Customers” and/or the “general public” are the target audiences to which the advertisers direct the aforementioned information. A “web page” is a unique, designated webpage allocated to a specific quick response code or to a set of quick response codes.

Advertising using quick response codes, as it is currently implemented, has two main problems: (1) surfing and entering web pages is done using smartphones rather than standard computers (the term “standard computer” refers here to tablets PCs, laptops, personal computers, etc.); and (2), the advertisers' identity is exposed during the transaction with the barcode company. The system and method, subject of the present invention, offer effective responses to both of these problems.

### THE INVENTION

The main objective of the present invention is to provide a method and system for advertising using quick response codes whereby the customer may enter the relevant web page by scanning the relevant quick response code using a smartphone or alternatively using a standard computer in conjunction with a smartphone. Another objective of the present invention is to enable advertisers to purchase quick response code stickers, as off-the-shelf products, that grant them access to the barcode company's server where they may manage the web pages in a way that does not require the advertisers to make direct contact with the barcode company and enables them to remain anonymous.

The method and system, subject of the present invention, refer to advertising using several quick response codes each of which is specific and unique. The quick response codes may be sold as stickers with the quick response codes printed on them, which enable the advertiser can apply them to products, packagings, business cards, catalogs, etc. Alternatively, the quick response codes can be sold as files that may be printed on products, packagings, newspapers, catalogs, etc.

Advertiser's access to allocated server space and website management system: The advertiser selects one of the quick response codes he has purchased and uses a smartphone to scan it. The website's operating system identifies that the smartphone number is not defined in the system and that a designated website has not yet been allocated to the specific quick response code which was scanned using that smartphone. The website's operating system thus concludes that the code was scanned by an advertiser who has purchased a set of quick response codes, either in the form of stickers, printed on packagings or in any other form. The website operating system immediately directs the advertiser to a web page from which the advertiser can manage the website and the web pages he designs and designates for each aforementioned quick response code or set of codes. In addition, an identification code is sent from the server to the advertiser's smartphone where it is embedded. After the identification code is embedded in the smartphone, it is transmitted to the server every time a sticker is scanned. So, whenever the advertiser scans a quick response code using the said smartphone, the website's operating system identifies the advertiser and he is directed immediately to the main web page to manage the relevant website and web pages. In other words, scanning the quick response code enables the advertiser to use the specific space allocated to him on the barcode company's server and to manage the website and web pages made available to him by the barcode company.

The advertiser may purchase a packet of quick response code stickers, as an off-the-shelf product in a store and on various sales sites, and apply the stickers to products, catalogs, cards, business cards, etc. Alternatively, the advertiser or packaging company may purchase quick response codes as files and print them on packagings, products, catalogs, newspapers, etc. The above-described advertising method and system using quick response codes enables advertisers to purchase quick response codes as an off-the-shelf product, to access a defined space on the barcode company's server, and to use the website management system, as mentioned, while maintaining anonymity and without having to maintain a direct business relationship with the barcode company.

The advertising method and system using quick response codes, subject of the present invention, can also include an option in the website's operating system that enables the customer to access and enter the relevant web pages using a standard computer as follows:

Stage 1: The customer uses a smartphone to scan the quick response code on the sticker, packaging, etc. (hereinafter referred to as the “on-sticker quick response code”).

Stage 2: The customer turns on the standard computer and surfs to the barcode company's website. The computer screen automatically displays a quick response code (hereinafter referred to as the “on-screen quick response code”. Note that the on-screen quick response code is a unique code. A different and unique quick response code appears on the screen at every entry to the barcode company's website, for that specific entry and for the specific computer used to enter the said website.

Stage 3: The customer uses the smartphone again to scan the on-screen quick response code. The website's operating system identifies two scans of two quick response codes from one specific smartphone: the on-sticker quick response code and the on-screen quick response code. The website's operating system thus concludes that the customer who scanned the on-sticker quick response code wishes to enter the web page using a standard computer and so displays the relevant web page on the screen of the computer whose on-screen quick response code was scanned using the said smartphone.

The advertising method and system using quick response codes, which is equipped with an operating system as described above, enables customers to surf and enter the relevant web pages on a standard computer by using a smartphone to scan quick response codes, as described above. Advertisers have an interest and a need to design and plan web pages for viewing on standard computers, commonly referred to as “widescreen display”, as opposed to the design of webpages intended for display on smartphones, which are referred to as “small screen display”. It is also noted that many attempts have been made to enable direct scanning of quick response codes using standard computers, including using cameras installed on them, all of which have been unsuccessful. The method and system, subject of the present invention, as described above, offer a creative, efficient and convenient solution to this problem.

Another object of the present invention is to provide any private person or business (hereinafter referred to as “the advertiser”) with the option of purchasing a quick response code sticker that enables the advertiser to: (a) access the barcode company's server, use a certain area of the server, and use the barcode company's site management system to design, edit and manage the advertiser's web page; (b) to receive two different links to the web page, whereby one link enables the advertiser to edit the web page and the second link is intended to be sent to other people (business clients, private acquaintances, etc.) so as to enable them to access and view the web page without being able to change or edit it. The said stickers can be used in a variety of situation: a person can, for instance, purchase a sticker, design a birthday greeting page and send the second link to friends and family, or, a person can purchase a sticker, upload personal photos or other materials to the web page and send the second link to acquaintances and friends, and so on.

What is claimed is:

1. A method and system for advertising using quick response codes that includes: (1) a set of quick response codes that can be purchased as an off-the-shelf product in the form of stickers or a computer file or in other forms so that the entity purchasing it may remain anonymous vis-a-vis the entity selling it; (b) a website designed to enable the entity that purchased the quick response codes to design, manage and store unique, designated web pages for each quick response code or for each set of quick response codes, as desired; (c) server space designated for the purchased quick response codes, which is used to store and manage the said web pages; (d) a website operating system that enables the purchaser of the quick response codes to enter the site management system and the web page management system in order to design, manage and store them, as desired.

2. The method and system described in Claim No. 1 whereby each of the said quick response codes can serve as a main quick response code for the site management system and for the management of the relevant web pages.

3. The method and system described in Claim No. 1 whereby the said operating system also includes the option of accessing and entering the said relevant web pages on a standard computer whereby whenever the website is entered using a standard computer, a unique quick response code is displayed on the computer screen. When this quick response code is scanned using a smartphone, before or after the on-sticker quick response code is scanned, the user is directed to the relevant web page designated for the on-sticker quick response code.

4. The method and system described in Claim No. 1 wherein the said advertiser receives two links to the said web page, wherein one link enables the advertiser to edit the web page and the second link enables others to access and view the said web page but without being able to edit or change the content of the said web page.
